(19) United States
(12) Patent Application Publication
(10) Pub. No.: US 2002/0174363 A1
(43) Pub. Date: Nov. 21, 2002

(54) Method and apparatus for providing an anonymous identity for a user

(75) Inventors: Thomas E. Chefalas, Somers, NY (US); Steven J. Mastrianni, Unionville, CT (US); Ajay Mohindra, Yorktown Heights, NY (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/859,711

(22) Filed: May 17, 2001

(51) Int. Cl. G06F 15/173

(52) U.S. Cl. 713/201

(57) ABSTRACT

A method, apparatus, and computer implemented instructions for an organization to provide anonymity to a user in a data processing system. A request is received from the user for an anonymous identity. The anonymous identity is generated for a user, wherein the anonymous identity includes contact information for the organization. The anonymous identity is associated with the user, wherein the user uses the anonymous identify to provide information on a network data processing system. Contacts received under the anonymous by the organization are selectively forwarded to the user.

### BACKGROUND OF THE INVENTION

1. Technical Field

The present invention relates generally to an improved data processing system, and in particular to a method and apparatus for processing information. Still more particularly, the present invention provides a method, apparatus, and computer implemented instructions for providing an anonymous identity for a user when providing information in a network data processing system.

2. Description of Related Art

The Internet, also referred to as an “internetwork”, is a set of computer networks, possibly dissimilar, joined together by means of gateways that handle data transfer and the conversion of messages from a protocol of the sending network to a protocol used by the receiving network. When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies, which must interact with virtually all segments of society such as the Internal Revenue Service and secretaries of state. Providing informational guides and/or searchable databases of online public records may reduce operating costs. Further, the Internet is becoming increasingly popular as a medium for commercial transactions.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). A URL is a special syntax identifier defining a communications path to specific information. Each logical block of information, accessible to a client, called a “page” or a “Web page”, is identified by a URL. The URL provides a universal, consistent method for finding and accessing this information, not necessarily for the user, but mostly for the user's Web “browser”. A browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database.

The Internet also is widely used to transfer applications to users using browsers. With respect to commerce on the Web, individual consumers and business use the Web to purchase various goods and services. In offering goods and services, some companies offer goods and services solely on the Web while others use the Web to extend their reach.

An increasing number of Web sites are requesting and recording personal information before providing access to the Web site content. Personal information requested by a Web site, may include, for example, a name, a contact address, a facsimile number, a phone number, and an e-mail address. Some Web sites also request information about demographics and personal income. Information submitted to these Web sites can be further released to other third parties for use for marketing of products. As a result, many users receive unsolicited “junk mail” at their home address, and computer e-mail accounts. The information also is used to make unsolicited telephone calls by telemarketers during the evening.

To address issues of privacy several companies such as “Anonymizer.com”, have started offering facilities to anonymously make postings on the Internet. Whenever a user wants to post articles to discussion groups, the user makes the posting through these sites. After the posting is made, the sites remove any identifying information such as e-mail address, name of the computer from which the posting was made and name of the user who made the posting. As a result, the article is posted on the network without any identity associated with the article. This mechanism removes the possibility of anyone extracting and recording any personal information about the user from the posting.

Some credit card companies offer a service in which a customer can request the credit card company to generate a unique identifier when a purchase is made on the Internet. This identifier is used by the customer for making a purchase in lieu of the credit card number. Thus, a customer can make online purchase without worrying about compromising the customer's credit card number.

One way to protect privacy on the Internet is to provide false information to the Web sites that request the information. However, using false information on the Internet precludes legitimate companies from contacting the customer, when the customer desires such contacts.

Further, one weakness of existing services is that the protection is offered only for individual services such as e-mail, article posting on the Internet, or credit card numbers. No blanket protection is provided to a user who wants to stay anonymous on the Internet and yet continue to gain access to information available on the Web sites that require disclosure of personal information. Secondly, existing services are designed such that the originator of the information always remains anonymous. These services do not allow a user to control the companies that can contact the user using the information provided on the Internet. Therefore, it would be advantageous to have an improved method and apparatus for providing a user anonymity for use in browsing information on a network data processing system, such as the Internet and at the same time allowing the user to control the companies that can contact the user using the personal information provided.

### SUMMARY OF THE INVENTION

The present invention provides a method, apparatus, and computer implemented instructions for an organization to provide anonymity to a user in a data processing system. A request is received from the user for an anonymous identity. The anonymous identity is generated for a user, wherein the anonymous identity includes contact information for the organization. The anonymous identity is associated with the user, wherein the user uses the anonymous identify to provide information on a network data processing system. Contacts received under the anonymous identity by the organization are selectively forwarded to the user.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system that may be implemented as a server in accordance with a preferred embodiment of the present invention;

FIG. 3 is a diagram illustrating components used in obtaining an anonymous identity in accordance with a preferred embodiment of the present invention;

FIG. 4 is a diagram illustrating entries for aliases and customer profiles in accordance with a preferred embodiment of the present invention;

FIG. 5 is a diagram of a customer profile in accordance with a preferred embodiment of the present invention;

FIG. 6 is a flowchart of a process used for generating an anonymous identity in accordance with a preferred embodiment of the present invention; and

FIG. 7 is a flowchart of a process used for processing contacts received for an anonymous identity in accordance with a preferred embodiment of the present invention.

### DETAILED DESCRIPTION OF THE PREFERRED EMBODIMENT

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 maybe, for example, personal computers or network computers. In the depicted example, server 104 provides data, such as boot files, operating system images, and applications to clients 108-112. Clients 108, 110, and 112 are clients to server 104. In these examples, the user at client 108 may contact server 104 to obtain an alias or anonymous identity for use in browsing or surfing other Web sites, such as one located on server 114 in network 102. Network data processing system 100 may include additional servers, clients, and other devices not shown.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

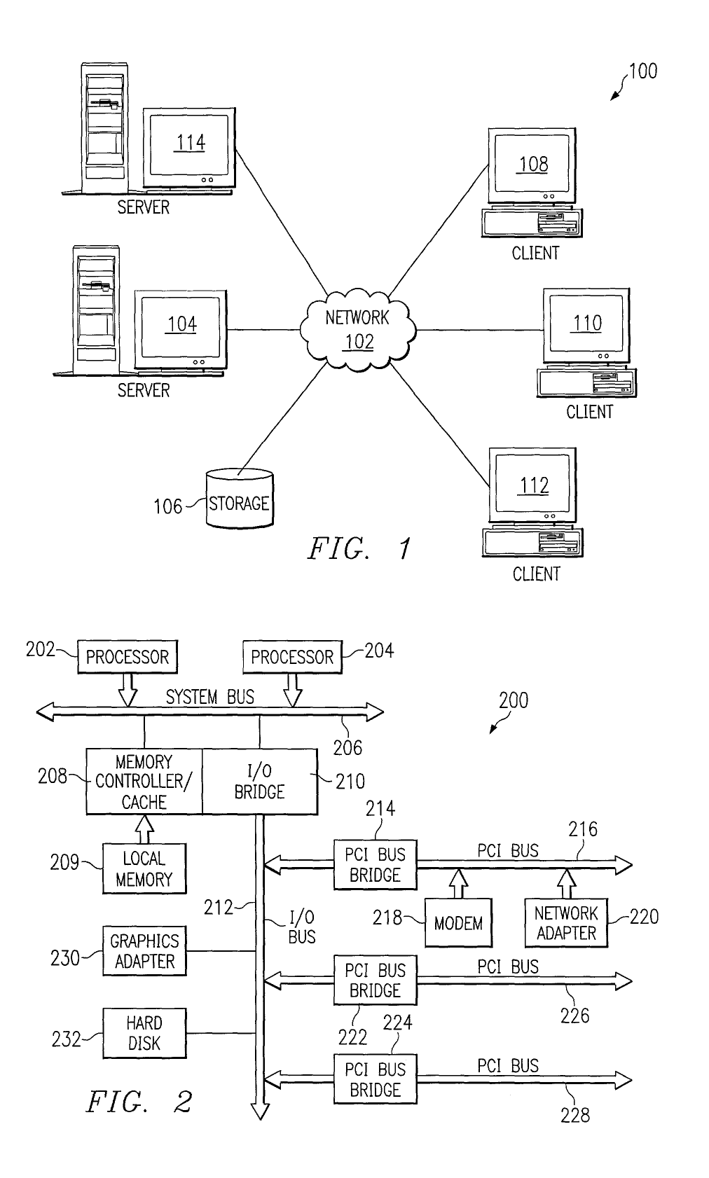

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communication links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or a LINUX operating system.

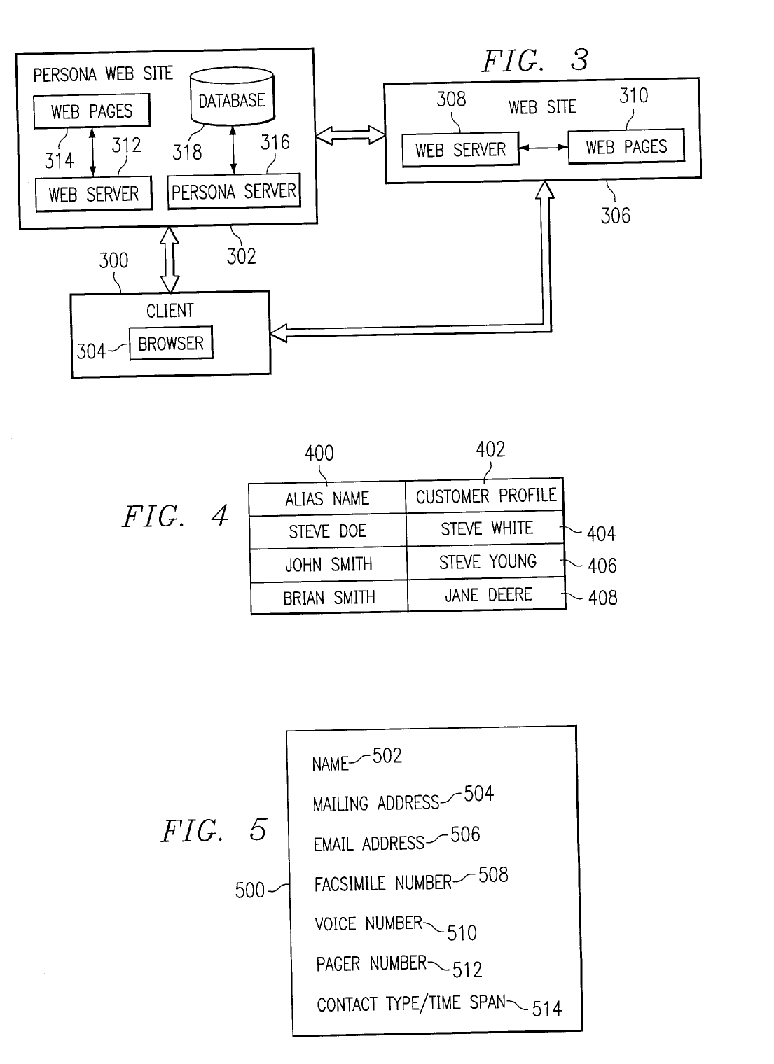

Turning next to FIG. 3, a diagram illustrating components used in obtaining an anonymous identity is depicted in accordance with a preferred embodiment of the present invention. In this example, a user at client 300 may contact persona Web site 302 through browser 304 to obtain an alias or anonymous identity to browse or search other Web sites, such as Web site 306. Persona Web site 302 and Web site 306 may be implemented using data processing system 200 in FIG. 2. Client 300 may be implemented using a data processing system similar to data processing system 200, which is optimized for client use, rather than server use. Browser 304 may be implemented using a browser, such as Internet Explorer from Microsoft Corporation. Additionally, client 300 may take other forms other than a desktop computer. For example, client 300 may be a personal digital assistant (PDA), a laptop, a mobile phone, or a kiosk.

Normally, Web site 306 receives a request from browser 304 at Web server 308. In response, Web server 308 selects a Web page from Web pages 310 and returns that page to browser 304 for presentation to the user. Oftentimes, a user is required to enter personal information to obtain access to information on a Web site. According to the present invention, a user at client 300 may send a request to Web server 312 in persona Web site 302. Web server 312, in this example, handles all requests for persona Web site 302 received from clients, such as client 300. In response, a Web page from Web pages 314 is returned to browser 304. In this example, the Web page provides options and requests information for generating an alias or an anonymous identity. The processes for generating the alias or anonymous identity are implemented in persona server 316. This server is implemented using an Enterprise Java bean. Database 318 is used by persona server 316 to store information, such as aliases or anonymous identities. When the user selects the option of creating a new alias, information is entered into an on-line identity profile and submitted as a request to Web server 312, which forwards this request to persona server 316. In response to the request, persona server 316 stores this information in database 318 and assigns fictitious contact information from a pool of contact identifiers within database 318. The assigned contact information includes, for example, telephone numbers, pager-ids, fax numbers, and e-mail addresses. These are actual contact points, which are monitored by persona server 316. Each alias or anonymous identity is uniquely associated with a user.

Persona server 316 also associates a life-span with the alias or anonymous identity. When the life-span expires the alias is rendered invalid. The life span of the alias may be set by the user or based on payment of fees by the user for the service.

After the personality information has been completely filled in, persona server 316 prompts the user to determine whether the user desire a forwarding capability with the alias. The forwarding capability allows selective forwarding of a request or contact sent to the user using the contact information for the alias. If the user specifies the option to establish forwarding, then persona server 316 displays the contact information screen to the user. The user may fill in the correct contact information such as telephone numbers, an e-mail address, and/or a pager-identifier to which any information received on the alias should be forwarded. The user also has the option of selectively filling the contact information profile. For example, the user may choose to contacted only via a telephone. The user also has the option of specifying policies associated with the contact information profile. The policies specify conditions under which information can be communicated back to the customer. A policy such as contact the user only after 4:30 p.m. would enable persona server 316 to forward telephone calls to the real telephone number only after 4:30 p.m. At other times, the calls are not forwarded.

Persona server 316 displays to the user the new online identity that has been created for the user. The customer can print the information on paper and use it to fill out information on Web sites that request the information. For example, a user at client 300 may contact Web site 306 and fill in contact information for the alias in response to requests from Web server 308 for personal contact information. In this example, the request may be for a name and an e-mail address. Web server 308 may then send an e-mail to the user using the e-mail address. In this case, the e-mail address is a real e-mail address, but fictitious to the user. The e-mail is received by persona server 316, which uses the e-mail address and/or name as an index to identify an entry or record for the profile associated with the alias. Upon locating the profile for the alias, persona server 316 may determine whether this e-mail should be forwarded to the actual e-mail address of the user. The determination of whether to forward the e-mail to the user is made using a policy, which may be defined by the user or by an administrator. If the e-mail is to be forwarded, the actual e-mail address of the user is identified and the e-mail if forwarded to that actual e-mail address. If a proper standard exists, then the identity information can be electronically transferred from the persona server 316 to the Web site 306. A service is provided through persona server 316 for an organization, such as an on-line business to collect fees. For example, a user may be billed a monthly fee for the alias. Alternatively, the user may be billed on a per forwarded contact basis, or on a per rejected contact basis. Additionally, persona server 316 also may provide a mechanism of deleting and modifying alias information for users.

With reference now to FIG. 4, a diagram illustrating entries for aliases and customer profiles is depicted in accordance with a preferred embodiment of the present invention. In this example, column 400 identifies aliases for entries within a database, while column 402 identifies customer profile names for those aliases. In the depicted examples, entries 404, 406, and 408 are examples of entries that may be found in database 318 in FIG. 3. In this illustration, an alias name is used an as index to identify profiles associated with a user. The customer profile name identifies the actual name of the user, in this example. The profile itself contains actual contact information for the user as well as any policies as to how and when contacts are to be forwarded to the user. Of course, other information may be used to identify the customer profile, such as an e-mail address or telephone number.

Turning next to FIG. 5, a diagram of a customer profile is depicted in accordance with a preferred embodiment of the present invention. Profile 500 is an example of a profile, which is associated with an alias. Profile 500 may be identified by the association of the profile with the alias name. In the depicted examples, profile 500 includes name 502, mailing address 504, e-mail address 506, facsimile number 508, voice number 510, pager number 512, and contact type/time span 514. Mailing address 504, e-mail address 506, facsimile number 508, voice number 510, and pager number 512 are fields in which actual contact information for the user may be found. Contact type/time span 514 is an example of a type of policy that may be used to selectively forward contacts to the user through the actual contact information. Contact type may indicate the type of contact that may be forwarded or the medium in which the contact is to be forwarded. For example, if only an e-mail address is found, only e-mail messages received for the alias associated with the user are forwarded to the user. Alternatively, contacts in other forms may be converted into a form for forwarding by e-mail. For example, a facsimile received for the user may be placed into an e-mail and sent to the user. The contact time may indicate during what time the contacts are to be forwarded to the user. For example, with e-mails, a user may desire to receive contacts in this form only on Mondays at 4:30 p.m.

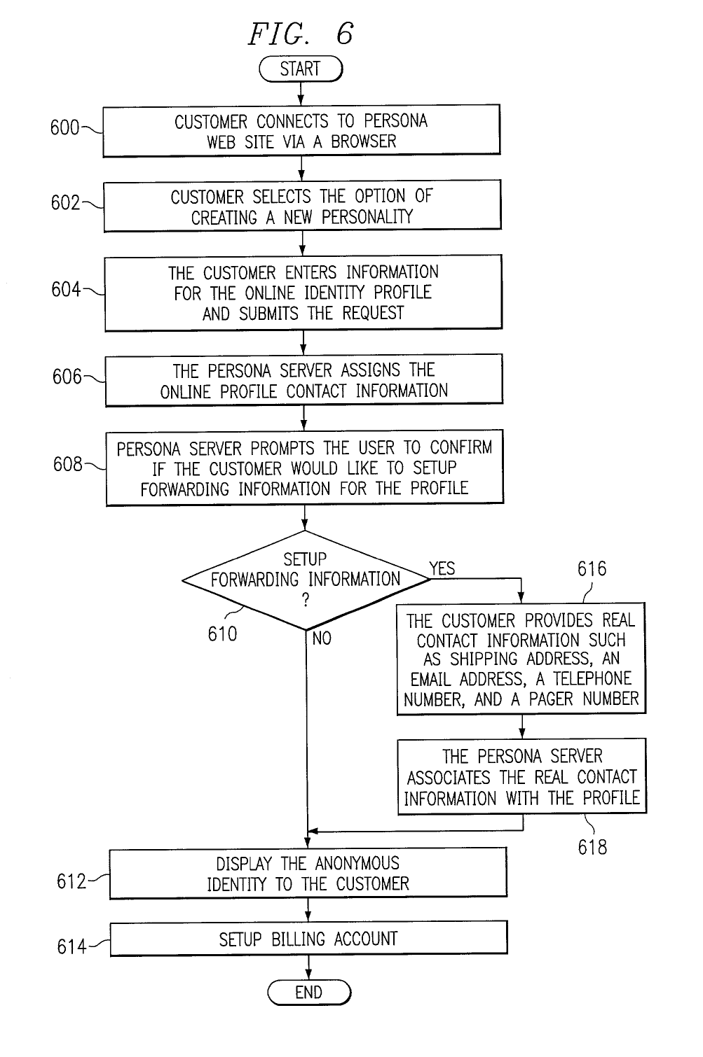

With reference now to FIG. 6, a flowchart of a process used for generating an anonymous identity is depicted in accordance with a preferred embodiment of the present invention. The process illustrated in FIG. 6 depicts the various steps taken by a user and by a persona server, such as persona server 316 in FIG. 3, to generate an alias or anonymous identity.

The process begins when a customer connects to the persona Web site via a browser (step 600). Next, the customer selects an option to create a new personality (step 602). The customer then enters information for an online identity profile and submits the request (step 604). The personal server assigns the online profile contact information (step 606). The online profile contact information may include, for example, the customer's shipping address, an e-mail address, a telephone number, and a pager number.

The personal server then prompts the user to confirm if the customer would like to setup forwarding information for the profile (step 608). A determination is then made as to whether forwarding information is setup (step 610). If forwarding information is not setup, the anonymous identity is displayed to the customer (step 612). Thereafter, a billing account is setup for the user (step 614) with the process terminating thereafter. If forwarding information is setup, the customer provides real contact information (step 616). The personal server associates the real contact information with the customer's profile (step 618) and the process proceeds to step 612 as described above.

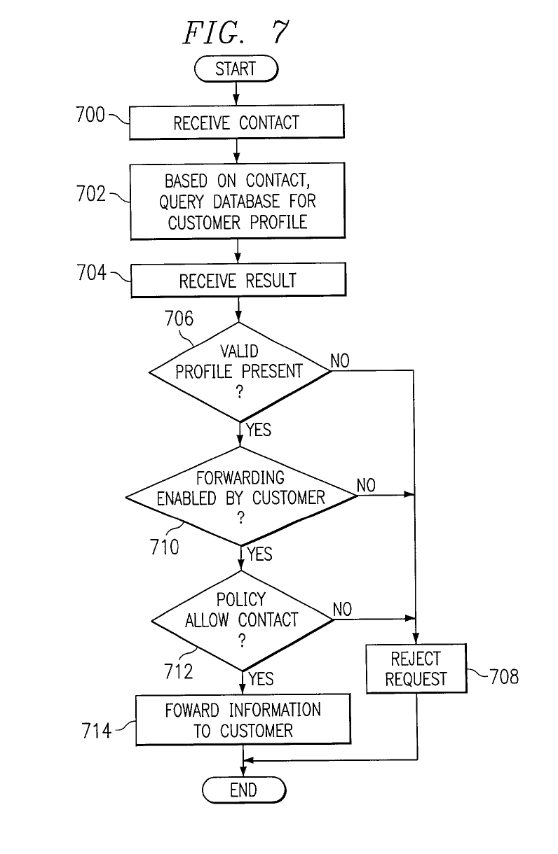

With reference now to FIG. 7, a flowchart of a process used for processing contacts received for an anonymous identity is depicted in accordance with a preferred embodiment of the present invention. The process illustrated in FIG. 7 may be implemented in a persona server, such as persona server 316 in FIG. 3.

The process begins by receiving a contact (step 700). Based on the contact received by the persona server, a database is queried for a profile (step 702). This query may be made using an alias name or other alias information in the contact. A result to this query is received (step 704). A determination is then made as to whether a valid customer profile is present (step 706). In these examples, the result may be a profile for the user that is associated with the alias or anonymous identity. Profile 500 in FIG. 5 is an example of a profile that may returned. Alternatively, a null value may be received to indicate that no profile is present or valid for this particular alias. If a valid customer profile is not present, the request is rejected (step 708) and the process terminates. Otherwise, a determination is made as to whether forwarding is enabled by the customer (step 710). If forwarding is enabled, a determination is then made as to whether the policy allows contact (step 712). For example, contact may or may not be allowed by the policy depending on the particular time and date. Alternatively, contact also may or may not be allowed based on the medium in which contact is received. If contact is allowed, information is forwarded to the customer (step 714) with the process terminating thereafter.

Turning back to step 712, if the policy does not allow contact, the process proceeds to step 708 as described above. With reference again to step 710, if forwarding is not enabled by the customer, the process proceeds to step 708.

Thus, the present invention provides an improved method, apparatus, and computer implemented instructions for providing a user an alias or an anonymous identity for use in browsing or searching for information on a network data processing system, such as the Internet. With this mechanism, the user may selectively receive contacts sent to the alias based on a policy. Of course, this mechanism may be applied to other types of network data processing systems other than the Internet. For example, these processes may be implemented in a local area network (LAN), a wide area network (WAN), or in an intranet.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for an organization to provide anonymity to a user, the method comprising the data processing system implemented steps of:
receiving a request from the user for an anonymous identity;
generating the anonymous identity for the user, wherein the anonymous identity includes contact information for the organization;
associating the anonymous identity with the user, wherein the user uses the anonymous identify to provide information on a network data processing system;
receiving a contact directed to the anonymous identity; and
selectively forwarding the contact to the user based on a policy.

2. The method of claim 1, wherein the data processing system is a Web server.

3. The method of claim 1 further comprising:
billing the user for the anonymous identity.

4. The method of claim 3, wherein the user is billed on a monthly basis.

5. The method of claim 3, wherein the user is billed for each contact forwarded to the user.

6. The method of claim 1, wherein the anonymous identity is valid for a selected period of time.

7. The method of claim 6, wherein the period of time is selected by the user.

8. The method of claim 1, wherein forwarding of contacts to the user based on the policy ceases when the anonymous identity is invalid.

9. The method of claim 1, wherein the contact information includes at least one of a voice telephone number, a facsimile telephone number, and e-mail address, a pager number, and mailing address.

10. The method of claim 1, wherein the profile specifies a type of contact that is to be forwarded.

11. The method of claim 10, wherein the type of contact includes at least one of a voice message, an e-mail message, and physical mail.

12. The method of claim 10, wherein the type of contact is a time when a contact is received.

13. The method of claim 1, wherein the profile causes selected contacts to be held and forwarded to the user at a selected time.

14. A method in a data processing system for providing anonymity to a user, the method comprising the data processing system implemented steps of:
receiving a contact, wherein the contact includes an identification of an entity;
comparing the identification of an entity in the contact to a database of aliases; and
responsive to identifying the user, selectively forwarding the contact to the user based on a policy.

15. The method of claim 14, wherein the policy specifies an event causing the contact to be forwarded.

16. The method of claim 15, wherein the event is a periodic event.

17. The method of claim 15, wherein the event is at least one of a selected time, a selected day, and a particular mode of contact.

18. The method of claim 17, wherein the mode of contact is at least one of voice message, an e-mail message, a page, and physical mail.

19. The method of claim 14 further comprising:
billing the user.

20. The method of claim 14, wherein the database of aliases includes a set of entries.

21. The method of claim 20, wherein each entry within the set of entries includes an alias, a user identification; and a policy used to selectively forward contacts to the user.

22. A data processing system comprising:
a bus system;
a communications unit connected to the bus system;
a memory connected to the bus system, wherein the memory includes as set of instructions; and
a processing unit connected to the bus system, wherein the processing unit executes the set of instructions to receive a request from the user for an anonymous identity; generate the anonymous identity for the user, wherein the anonymous identity includes contact information for the organization; associate the anonymous identify with the user, wherein the user uses the anonymous identity to provide information on a network data processing system; receive a contact directed to the anonymous identity; and selectively forward the contact to the user based on a policy.

23. The data processing system of claim 22, wherein the data processing system is a Web server.

24. The data processing system of claim 22, wherein the processor unit further executes the set of instructions to bill the user for the anonymous identity.

25. The data processing system of claim 24, wherein the user is billed on a monthly basis.

26. The data processing system of claim 24, wherein the user is billed for each contact forwarded to the user.

27. The data processing system of claim 22, wherein the anonymous identity is valid for a selected period of time.

28. The data processing system of claim 27, wherein the period of time is selected by the user.

29. The data processing system of claim 22, wherein forwarding of contacts to the user based on the policy ceases when the anonymous identity is invalid.

30. The data processing system of claim 22, wherein the contact information includes at least one of a voice telephone number, a facsimile telephone number, and e-mail address, a pager number, and mailing address.

31. The data processing system of claim 22, wherein the profile specifies a type of contact that is to be forwarded.

32. The data processing system of claim 31, wherein the type of contact includes at least one of a voice message, an e-mail message, and physical mail.

33. The data processing system of claim 31, wherein the type of contact is a time when a contact is received.

34. The data processing system of claim 22, wherein the profile causes selected contacts to be held and forwarded to the user at a selected time.

35. A data processing system comprising:
a bus system;
a communications unit connected to the bus system;
a memory connected to the bus system, wherein the memory includes as set of instructions; and
a processing unit connected to the bus system, wherein the processing unit executes the set of instructions to receive a contact, wherein the contact includes an identification of an entity; compare the identification of an entity in the contact to a database of aliases; and selectively forward the contact to the user based on a policy in response to identifying the user.

36. The data processing system of claim 35, wherein the policy specifies an event causing the contact to be forwarded.

37. The data processing system of claim 36, wherein the event is a periodic event.

38. The data processing system of claim 36, wherein the event is at least one of a selected time, a selected day, and a particular mode of contact.

39. The data processing system of claim 38, wherein the mode of contact is at least one of voice message, an e-mail message, a page, and physical mail.

40. The data processing system of claim 35, wherein the processing unit further execute the set of instructions to bill the user.

41. The data processing system of claim 35, wherein the database of aliases includes a set of entries.

42. The data processing system of claim 41, wherein each entry within the set of entries includes an alias, a user identification; and a policy used to selectively forward contacts to the user.

43. A data processing system for an organization to provide anonymity to a user, comprising:
first receiving means for receiving a request from the user for an anonymous identity;
generating means for generating the anonymous identity for the user, wherein the anonymous identity includes contact information for the organization;
associating means for associating the anonymous identity with the user, wherein the user uses the anonymous identify to provide information on a network data processing system;
second receiving means for receiving a contact directed to the anonymous identity; and
forwarding means for selectively forwarding the contact to the user based on a policy.

44. The data processing system of claim 43, wherein the data processing system is a Web server.

45. The data processing system of claim 44 further comprising:
billing means for billing the user for the anonymous identity.

46. The data processing system of claim 45, wherein the user is billed on a monthly basis.

47. The data processing system of claim 45, wherein the user is billed for each contact forwarded to the user.

48. The data processing system of claim 44, wherein the anonymous identity is valid for a selected period of time.

49. The data processing system of claim 48, wherein the period of time is selected by the user.

50. The data processing system of claim 43, wherein forwarding of contacts to the user based on the policy ceases when the anonymous identity is invalid.

51. The data processing system of claim 43, wherein the contact information includes at least one of a voice telephone number, a facsimile telephone number, and e-mail address, a pager number, and mailing address.

52. The data processing system of claim 52, wherein the profile specifies a type of contact that is to be forwarded.

53. The data processing system of claim 52, wherein the type of contact includes at least one of a voice message, an e-mail message, and physical mail.

54. The data processing system of claim 43, wherein the type of contact is a time when a contact is received.

55. The data processing system of claim 43, wherein the profile causes selected contacts to be held and forwarded to the user at a selected time.

56. A data processing system for providing anonymity to a user comprising:
receiving means for receiving a contact, wherein the contact includes an identification of an entity; comparing means for comparing the identification of an entity in the contact to a database of aliases; and
forwarding means, responsive to identifying the user, for selectively forwarding the contact to the user based on a policy.

57. The data processing system of claim 56, wherein the policy specifies an event causing the contact to be forwarded.

58. The data processing system of claim 57, wherein the event is a periodic event.

59. The data processing system of claim 57, wherein the event is at least one of a selected time, a selected day, and a particular mode of contact.

60. The data processing system of claim 59, wherein the mode of contact is at least one of voice message, an e-mail message, a page, and physical mail.

61. The data processing system of claim 56 further comprising:
billing means for billing the user.

62. The data processing system of claim 56, wherein the database of aliases includes a set of entries.

63. The data processing system of claim 62, wherein each entry within the set of entries includes an alias, a user identification; and a policy used to selectively forward contacts to the user.

64. A computer program product in a computer readable medium an organization to provide anonymity to a user, the computer program product comprising:
first instructions for receiving a request from the user for an anonymous identity; and
second instructions for generating the anonymous identity for the user, wherein the anonymous identity includes contact information for the organization;
third instructions for associating the anonymous identity with the user, wherein the user uses the anonymous identify to provide information on a network data processing system;
fourth instructions for receiving a contact directed to the anonymous identity; and
fifth instructions for selectively forwarding the contact to the user based on a policy.

65. The computer program product of claim 64, wherein the data processing system is a Web server.

66. The computer program product of claim 64 further comprising:
sixth instructions for billing the user for the anonymous identity.

67. The computer program product of claim 66, wherein the user is billed on a monthly basis.

68. The computer program product of claim 66, wherein the user is billed for each contact forwarded to the user.

69. The computer program product of claim 64, wherein the anonymous identity is valid for a selected period of time.

70. The computer program product of claim 69, wherein the period of time is selected by the user.

71. The computer program product of claim 64, wherein forwarding of contacts to the user based on the policy ceases when the anonymous identity is invalid.

72. The computer program product of claim 64, wherein the contact information includes at least one of a voice telephone number, a facsimile telephone number, and e-mail address, a pager number, and mailing address.

73. The computer program product of claim 73, wherein the profile specifies a type of contact that is to be forwarded.

74. The computer program product of claim 73, wherein the type of contact includes at least one of a voice message, an e-mail message, and physical mail.

75. The computer program product of claim 64, wherein the type of contact is a time when a contact is received.

76. The computer program product of claim 64, wherein the profile causes selected contacts to be held and forwarded to the user at a selected time.

77. A computer program product in a computer readable medium for providing anonymity to a user, the computer program product comprising:
first instructions for receiving a contact, wherein the contact includes an identification of an entity;
second instructions for comparing the identification of an entity in the contact to a database of aliases; and
third instructions, responsive to identifying the user, for selectively forwarding the contact to the user based on a policy.

78. The computer program product of claim 77, wherein the policy specifies an event causing the contact to be forwarded.

79. The computer program product of claim 78, wherein the event is a periodic event.

80. The computer program product of claim 78, wherein the event is at least one of a selected time, a selected day, and a particular mode of contact.

81. The computer program product of claim 80, wherein the mode of contact is at least one of voice message, an e-mail message, a page, and physical mail.

82. The computer program product of claim 77 further comprising:
fourth instructions for billing the user.

83. The computer program product of claim 77, wherein the database of aliases includes a set of entries.

84. The computer program product of claim 83, wherein each entry within the set of entries includes an alias, a user identification; and a policy used to selectively forward contacts to the user.
